(19) United States
(12) Patent Application Publication
(10) Pub. No.: US 2001/0036348 A1
(43) Pub. Date: Nov. 1, 2001

(54) Method of fabricating an optical fiber with varying chromatic dispersion

(76) Inventors: Jean-Claude Rousseau, Chatou (FR); Jean-Francois Chariot, Marly Le Roi (FR)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/808,043

(22) Filed: Mar. 15, 2001

(30) Foreign Application Priority Data
Mar. 16, 2000 (FR) 00 03 372

(51) Int. Cl. G02B 6/16; C03B 37/023

(52) U.S. Cl. 385/123; 65/435

(57) ABSTRACT

The invention proposes to fabricate an optical fiber by drawing a preform including several layers, at least one of which has a different viscosity to the other layers at the drawing temperature. The drawing tension is varied during drawing to obtain a fiber having a constant diameter and a varying profile. The chromatic dispersion of the fiber can therefore vary along the fiber. The invention applies to the fabrication of dispersion managed fibers (DMF).

The invention relates to optical fibers used in particular for telecommunication networks and more precisely to the fabrication of optical fibers.

### BACKGROUND OF THE INVENTION

Fabricating optical fibers by fabricating preforms doped radially as a function of the required index profile in the fiber and then drawing the preform to obtain the optical fiber is known in the art. The preform generally has a doped core and a silica cladding deposited around the core. In this context, the index profile is generally qualified as a function of the shape of the graph of the function that associates the radius of the fiber to the refractive index. The distance r from the center of the fiber is conventionally plotted on the abscissa axis and the difference between the refractive index and the refractive index of the cladding of the fiber on the ordinate axis. Thus the expressions “stepped index profile”, “trapezium index profile” and “triangular index profile” are used to refer to graphs which are respectively step-shaped, trapezium-shaped and triangular. These curves generally represent the theoretical or set point profile of the fiber and fiber fabrication constraints can lead to a significantly different profile. The index variations are achieved by doping, for example with germanium or phosphorus.

In some transmission applications it is desirable for the propagation characteristics of the optical fiber—and especially its chromatic dispersion—to vary along the fiber. This is the case in the field of soliton transmission in particular. It has been proposed to use fibers having a chromatic dispersion decreasing with distance or fibers with a chromatic dispersion having alternating non-zero values of opposite sign. The latter fibers are referred as “dispersion managed fibers”.

WO-A-97 30944 proposes a method of fabricating optical fiber whose properties vary axially. The document proposes advancing at variable speed in a drawing furnace a glass cylinder forming the core of the fiber and a glass annulus surrounding the glass cylinder and forming the cladding of the fiber. The speeds are chosen so that the fiber formed by drawing has a constant diameter, the diameter of the core varying along the fiber. This solution produces fibers whose dispersion varies along the fiber, for example decreasing dispersion fibers or dispersion managed fibers. The drawback of the method described in the above document is its complexity.

WO-A-98 25861 describes another solution for fabricating fibers whose transmission characteristics vary along the fiber. A first embodiment described in the document proposes to form a preform by depositing layers having a thickness increasing from one end of the preform to the other. The conical preform core obtained in this way is surrounded by a cladding before drawing the fiber. In a second embodiment described in the document a preform is formed by depositing layers of constant thickness but with varying proportions of dopant. In either case, drawing the preform produces a fiber whose propagation characteristics vary as a function of the position along the fiber.

EP-A-0 737 873 proposes various methods of fabricating chromatic dispersion managed fibers. In a first embodiment, the fiber is subjected after drawing to periodic ultraviolet irradiation which locally increases the index of the doped parts. In a second embodiment the preform core is machined to feature alternating parts of different diameter. A cladding deposited around the core gives the preform a constant diameter. In a third embodiment the preform is heated locally and drawn, which reduces its diameter in the heated area. In a fourth embodiment the preform is heated and compressed longitudinally. In a fifth embodiment the preform core has a constant diameter but the cladding is machined to feature alternating sections with different diameters; the fiber is drawn to a constant diameter. In a sixth embodiment sleeves are added around the preform to define the larger diameter areas. In a final embodiment two preforms with different characteristics are produced, sections cut from them, and alternating sections from the two preforms assembled in a sleeve.

K. Nakajima et al. in “Design of dispersion managed fiber and its FWM suppression performance”, OFC'99, ThG3, describe a dispersion managed fiber whose various dispersion ranges are obtained by controlling the diameter of the fiber by changing the drawing speed. The fiber has alternating sections with respective diameters of 122 μm and 127 μm with a respective chromatic dispersion of ±1 ps/(nm·km). This solution is not satisfactory in practice because the variations in the diameter of the fiber relative to the standard diameter of 125 μm cause mechanical problems, for example when connecting the fibers.

### OBJECT AND SUMMARY OF THE INVENTION

The invention proposes a method of fabricating a dispersion managed fiber that simplifies fabrication compared to prior art methods.

The invention relates to a method of fabricating an optical fiber by drawing a preform having a core and a sleeve, the core being formed of a plurality of layers, at least one of which has a different viscosity than the other layers at the drawing temperature, in which method the drawing tension is varied at least once during drawing.

Said layer is advantageously doped with a dopant that reduces viscosity. The dopant can be chosen from the group comprising aluminum, titanium, and zirconium. The dopant in said layer is present in a proportion from 500 ppm to 1%, for example.

In one embodiment the preform has a trapezium index profile or a trapezium with at least one ring index profile.

In one embodiment the drawing is performed with a constant fiber diameter. The drawing tension is advantageously varied from 40 grams (g) to 150 g. It can be varied continuously or discretely during drawing. In one embodiment the drawing tension is varied during a time period corresponding to drawing 1 km of fiber.

### BRIEF DESCRIPTION OF THE DRAWINGS

Other features and advantages of the invention will become apparent on reading the following description of embodiments of the invention, which description is given by way of example only and with reference to the accompanying drawings, in which:

FIG. 1 is a diagrammatic representation of the set point index profile of a preform according to the invention, and

FIGS. 2 to 4 are diagrammatic representations of the set point index profile of fiber according to the invention.

### MORE DETAILED DESCRIPTION

To vary the chromatic dispersion along a fiber, the invention proposes providing the preform with a layer whose viscosity is different to that of the other layers of the preform. During drawing, variations in the drawing tension then vary the refractive index, and therefore the chromatic dispersion, in this layer. The invention simplifies the fabrication of the preform and does not entail any complex machining of the preform, as proposed in EP-A-0 737 873. It also produces a fiber of constant diameter and therefore avoids mechanical problems caused by diameter variations. The invention can be applied as explained to vary the chromatic dispersion along the fiber; more generally, it is used to vary at least one propagation characteristic of the fiber.

According to the invention, the layer that has a different viscosity is the outermost layer of the preform core. In this way drawing can produce a ring in the index profile.

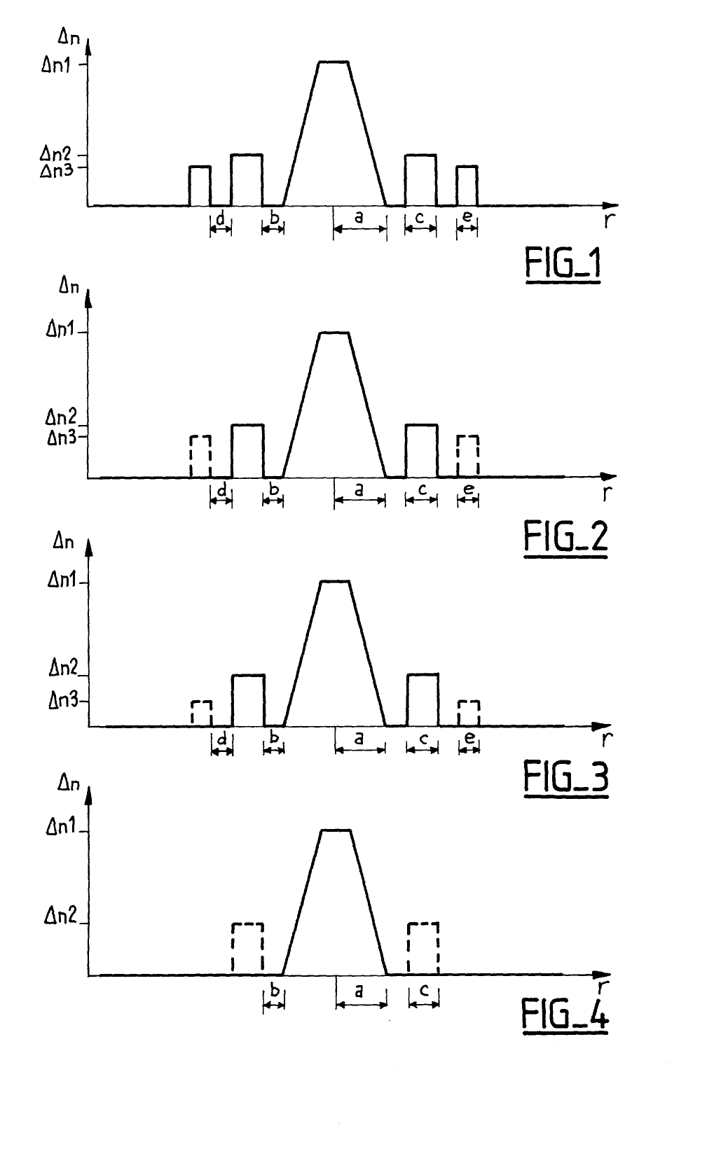

FIG. 1 is a diagrammatic representation of the set point index profile of a preform used in a first embodiment of the invention, in which the index profile is a trapezium with two rings index profile. Starting from the center of the preform, there are:

a central part with a substantially constant index greater than or equal to the index of the cladding;

a part surrounding that central part, over which the index decreases substantially linearly; this part and the central part constitute a trapezium profile;

an annular part whose index is equal to the index of the cladding;

a first ring whose index is substantially constant and greater than the index of the cladding;

an annular part whose index is equal to the index of the cladding;

a second ring; and

the cladding.

The index profile is therefore a trapezium with two rings index profile. In accordance with the invention, the viscosity of at least one layer of the preform is modified relative to the other layers of the preform. In the example, the viscosity is modified in the outermost layer of the preform core, which forms a second ring or a first ring. Dopants can be added for this purpose, for example aluminum, in proportions of around 5 000 ppm, and more precisely from 500 ppm to 1%. Adding aluminum in this range lowers the viscosity of the glass in the vicinity of the drawing temperature. Other dopants can be used for the same purpose, for example titanium or zirconium.

Adding aluminum in proportions close to 10 ppm, or more generally in proportions less than 200 ppm, hardens the silica. These properties can be used to dope the other layers of the preform and thereby increase the viscosity difference between the various layers of the preform.

The index and radius values for the FIG. 1 embodiment are as follows. The radius values are given in proportion to the radius a of the central part of the trapezium. In the preform, the radius a is typically of the order of 2 mm.

The ratio r between the radii of the bases of the trapezium—the radius of the central part and the radius of the part in which the index decreases substantially linearly—is 0.3. The difference Δn1 between the index of the trapezium and the index of the cladding is 10.2×10−3.

The cladding extends between the trapezium and the first ring and has a thickness b of 0.6−a.

The first ring has a thickness c which has the value 0.8×a and an index difference Δn2 relative to the cladding of 3.35×10^{-3.}

The cladding between the first ring and the second ring has a thickness d of 0.6×a. Its index is equal to the index of the cladding.

In accordance with the invention, the second ring has a different viscosity to the other layers of the preform; as indicated above, the viscosity can be varied by adding aluminum in a proportion from 500 ppm to 1% and preferably in a proportion close to 5 000 ppm. The thickness e of the second ring in the preform is 0.5×a. The index difference Δn3 relative to the index of the cladding is zero in the preform and is zero for drawing at a low tension. It is 2.6×10⁻³ for drawing at a high tension, as explained hereinafter.

There is a cladding around the second ring, for example extending out to an outside diameter of 60 mm.

The FIG. 1 preform can be used to fabricate the FIG. 2 fiber in fiber drawing apparatus known in the art. The layer forming the second ring has a different viscosity from the other layers of the preform; because of this, unlike the situation in the prior art, the profile of the fiber obtained by drawing the preform is not necessarily directly geometrically similar to the profile of the preform: the profile of the fiber obtained depends on the drawing tension. To be more precise, at constant fiber diameter, the greater the drawing tension, the greater the index of the low viscosity layer; conversely, as the drawing tension decreases, the index of the layer having a low viscosity increases less. Accordingly, the viscosity difference is reflected on cooling in different levels of compression or tension stresses and therefore different indices.

The tension to be applied depends on the viscosity difference of the layer relative to the rest of the preform. In the case of doping the layer with aluminum in the proportions given above, the drawing tension can advantageously vary from 40 g to 150 g. The index difference between the doped layer and the cladding varies in a range from 1 to 3×10⁻³. More generally, for implementing the invention, the variation of the index can be modelled as a function of the tension by an affine function of the type Δn=a.T+b, where An is the index difference compared to the cladding, T the drawing tension, and a and b two real coefficients which depend on the composition of the various layers. The coefficients can be determined experimentally.

FIG. 2 is a diagrammatic representation of the set point profile of a first embodiment of a fiber according to the invention. In this embodiment the dispersion is varied from −1 ps/(nm·km) to +1 ps/(nm·km) by varying the drawing tension from 40 g to 150 g. The figure shows in full line the profile for a drawing tension of 40 g (referred to as a “low” tension) and in dashed line the profile for a drawing tension of 150 g (a “high” tension). The difference lies entirely in the existence of a second ring.

The ring has the following characteristics. For a low drawing tension, the profile is a trapezium and ring profile; with the same notation as above:

Ratio r′ of bases of trapezium=0.3

Core radius a′=3.35 μm

Trapezium index Δn1=10.2×10⁻³

Cladding width b′ from trapezium to first ring=0.6×a′

Thickness c′ of first ring=0.8×a′

Index Δn2 of first ring=3.35×10⁻³

For a high drawing tension the profile is a trapezium with two rings profile; the characteristics of the fiber are as follows:

Ratio r′ of bases of trapezium=0.3

Core radius a′=3.35 μm

Trapezium index Δn1=10.2×10⁻³

Cladding width b′ from trapezium to first ring=0.6×a′

Thickness c′ of first ring=0.8×a′

Index Δn2 of first ring=3.35×10⁻³

Cladding width d′ from first to second rings=0.5×a′

Thickness e′ of second ring=0.5×a′

Index Δn3 of second ring=2.6×10⁻³

The high drawing tension therefore produces the second ring.

The drawing tension can vary continuously or discretely. In a preferred embodiment, the drawing tension is maintained constant at the low value for a time period corresponding to 10 km of fiber and is then changed to the high value for the same time period, and so on. This produces dispersion managed fiber with segments 20 km long. The change of profile between two segments is effected over a distance of less than 2 km and the dispersion is from −0.5 to +0.5 over a distance of only 1 km. In this case the drawing tension can be said to vary discretely.

FIG. 3 is a diagrammatic representation of the set point profile of a second embodiment of a fiber according to the invention. In this embodiment, the dispersion is varied from +2.2 ps/(nm·km) to +0.8 ps/(nm·km) by varying the drawing tension from 40 g to 150 g. As in FIG. 2, the figure shows in full line the profile for a drawing tension of 40 g (“low” tension) and in dashed line the profile for a drawing tension of 150 g (“high” tension). The difference lies entirely in the existence of a second ring.

The ring has the following characteristics. For a low drawing tension, the profile is a trapezium and ring profile; with the same notation as above:

Ratio r′ of bases of trapezium=0.3

Core radius a′=3.35 μm

Trapezium index Δn1=9.9×10⁻³

Cladding width b′ from trapezium to first ring=0.6×a′

Thickness c′ of first ring=0.8×a′

Index Δn2 of first ring=3.35×10⁻³

For a high drawing tension the profile is a trapezium with two rings profile; the characteristics of the fiber are as follows:

Ratio r′ of bases of trapezium=0.3

Core radius a′=3.35 μm

Trapezium index Δn1=9.9×10⁻³

Cladding width b′ from trapezium to first ring=0.6×a′

Thickness c′ of first ring=0.8×a′

Index Δn2 of first ring=3.35×10⁻³

Cladding width d′ from first to second rings=0.5×a′

Thickness e′ of second ring=0.5×a′

Index 3 of second ring=2×10⁻³

The dispersion can be varied along the fiber as in FIG. 2. Instead, the dispersion is preferably varied continuously along the fiber, i.e. changed from one profile to another over distances greater than 10 km, for example of the order of 20 km. In this case the dispersion is always positive and decreases continuously. The FIG. 3 fiber can be obtained using a preform similar to that shown in FIG. 1 in which the value of the index Δn1 of the trapezium is 9.9×10^{-3.}

FIG. 4 is a diagrammatic representation of the set point profile of a third embodiment of a fiber according to the invention. In this embodiment, the dispersion is varied from +3.2 ps/(nm·km) to +1.2 ps/(nm·km) by varying the drawing tension from 40 g to 150 g. As in FIGS. 2 and 3, the figure shows in full line the profile for a drawing tension of 40 g (“low” tension) and in dashed line the profile for a drawing tension of 150 g (“high” tension). The difference lies entirely in the existence of a ring.

The ring has the following characteristics. For a low drawing tension, the profile is a trapezium with no ring profile; with the same notation as above:

Ratio r′ of bases of trapezium=0.3

Core radius a′=3.23 μm

Trapezium index Δn1=10.1×10⁻³

For a high drawing tension the profile is a trapezium with one ring profile; the characteristics of the fiber are as follows:

Ratio r′ of bases of trapezium=0.3

Core radius a′=3.23 μm

Trapezium index Δn1=10.1×10⁻³

Cladding width b′ from trapezium to ring=0.5×a′

Thickness c′ of ring=0.9×a′

Index Δn2 of ring=2.9×10⁻³

The dispersion can vary along the fiber as in FIGS. 2 and 3 and preferably varies continuously. The FIG. 4 fiber can be obtained from a preform having a trapezium and ring index profile, the layer corresponding to the ring having a different viscosity than the other layers of the preform. The index and the dispersion can be varied as in FIG. 2 over a chosen length.

The examples consider dispersion managed fibers with dispersions having alternating constant values. The invention can also be used to fabricate fibers whose dispersion is varied continuously, by varying the drawing tension continuously during drawing.

Of course, the present invention is not limited to the examples and embodiments described and shown and lends itself to many variants that will suggest themselves to the skilled person. In the above examples, the refractive index is varied by means of a ring, i.e. by means of variation of viscosity in the outermost doped layers of the preform. The viscosity could also be varied in other parts of the preform. The examples also consider a fiber which has a trapezium with one or two rings profile. The invention also applies to other types of profile, for example pedestal and ring profiles, or rectangle with ring profiles. The cladding between the trapezium and the ring or rings can have an index different from the index of the cladding, and in particular an index lower than the index of the cladding.

1. A method of fabricating an optical fiber with varying chromatic dispersion by drawing a preform having a core and a sleeve, the core being formed of a plurality of layers, at least one of which has a different viscosity than the other layers at the drawing temperature, in which method the drawing tension is varied at least once during drawing.

2. The method of claim 1, wherein the drawing is performed with a constant fiber diameter.

3. The method of claim 1, wherein the drawing tension is varied from 40 g to 150 g.

4. The method of claim 1, wherein the drawing tension is varied continuously.

5. The method of claim 1, wherein the drawing tension is varied discretely.

6. The method of claim 5, wherein the drawing tension is varied during a time period corresponding to drawing 1 km of fiber.

7. The method of claim 1, wherein said layer having a different viscosity is doped with a dopant that reduces viscosity.

8. The method of claim 7, wherein the dopant is chosen from the group comprising aluminum, titanium, and zirconium.

9. The method of claim 7, wherein the dopant in said layer is present in a proportion from 500 ppm to 1%.

10. The method of claim 1, wherein said preform has a trapezium index profile or a trapezium with at least one ring index profile.

11. An optical fiber with varying chromatic dispersion obtained by a method according to claim 1.
